(19) United States
(12) Patent Application Publication
(10) Pub. No.: US 2004/0003145 A1
(43) Pub. Date: Jan. 1, 2004

(54) Method and apparatus to transfer information

(76) Inventors: Eyal Schneiderman, Rosh-Haain (IL); Motti Moscovich, Rosh-Haain (IL)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/186,001

(22) Filed: Jun. 27, 2002

(51) Int. Cl. G06F 13/28

(52) U.S. Cl. 710/25

(57) ABSTRACT

Briefly, in accordance with an embodiment of the invention, a method and apparatus to transfer information is provided, wherein the method includes monitoring activity on a bus during a transfer of information from a device using the bus and generating a direct memory access (DMA) request based on the bus activity.

### BACKGROUND

A microprocessor in a computing system may initiate and control the transfer of information within the system. A microprocessor may operate at a relatively greater speed than other components within the system. Accordingly, the microprocessor may incur a significant amount of idle time while waiting for data to be transferred between two relatively slower peripheral devices after initiating the transfer of data.

Thus, there is a continuing need for alternate ways to transfer information.

### BRIEF DESCRIPTION OF THE DRAWINGS

The subject matter regarded as the invention is particularly pointed out and distinctly claimed in the concluding portion of the specification. The claimed subject matter, however, both as to organization and method of operation, together with objects, features, and advantages thereof, may best be understood by reference to the following detailed description when read with the accompanying drawings in which:

FIG. 1 is a block diagram of a computing system in accordance with an embodiment of the claimed subject matter;

FIG. 2 is a block diagram of a direct memory access (DMA) request generator in accordance with an embodiment of the claimed subject matter; and

FIG. 3 is a block diagram illustrating a portable communication device in accordance with an embodiment of the claimed subject matter.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the claimed subject matter. However, it will be understood by those skilled in the art that the claimed subject matter may be practiced without these specific details. In other instances, well-known methods, procedures, components and circuits have not been described in detail so as not to obscure the claimed subject matter.

Embodiments of the claimed subject matter may include an apparatus for performing the operations herein. This apparatus may be specially constructed for the desired purposes, or it may comprise a general purpose computing device selectively activated or reconfigured by a program stored in the device. Such a program may be stored on a storage medium, such as, but is not limited to, any type of disk including floppy disks, optical disks, CD-ROMs, magnetic-optical disks, electromechanical disks, read-only memories (ROMs), random access memories (RAMs), electrically programmable read-only memories (EPROMs), electrically erasable and programmable read only memories (EEPROMs), flash memory, magnetic or optical cards, or any other type of media suitable for storing electronic instructions and data.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

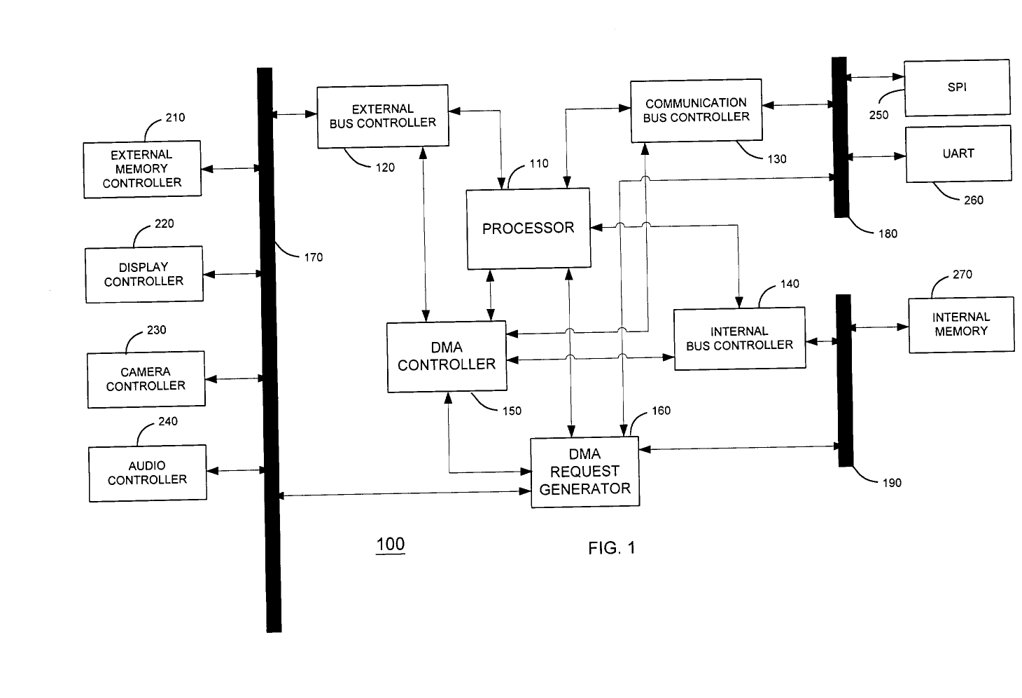

Turning to FIG. 1, an embodiment of a computing system 100 is illustrated. Computing system 100 may be used in a variety of applications such as, for example, a personal digital assistant (PDA), a two-way pager, a cellular phone, a portable computer, a desktop computer, a workstation, a server, or video equipment. Although it should be pointed out that the scope and application of the claimed subject matter is in no way limited to these examples.

In this embodiment, computing system 100 may comprise a processor 110 that may be connected to an external bus controller 120, a communication bus controller 130, an internal bus controller 140, a direct memory access (DMA) controller 150, and a DMA request generator 160. DMA controller 150 may be connected to external bus controller 120, communication bus controller 130, internal bus controller 140, and DMA request generator 160. External bus controller 120 may be connected to a bus 170; communication bus controller 130 may be connected to a bus 180; and internal bus controller 140 may be connected to a bus 190. DMA request generator 160 may be connected to buses 170, 180, and 190. Computing system 100 may further comprise an internal memory 270 connected to bus 190. Although not shown in the embodiment illustrated in FIG. 1, in alternate embodiments, processor 110 may be directly connected to buses 170, 180, and 190. In addition, in alternate embodiments, DMA controller 150 may be directly connected to buses 170, 180, and 190.

In addition, computing system 100 may comprise devices to interface to peripheral devices (not shown) such as, for example, a digital camera, a display, a keyboard, a memory device, a printer, an audio device, etc. These peripheral devices may also be referred to as Input/Output (I/O) devices or external devices. In the embodiment illustrated in FIG. 1, computing system 100 may include the following devices to interface to peripheral devices: an external memory controller 210, a display controller 220, a camera controller 230, an audio controller 240, a serial peripheral interface (SPI) 250, a universal asynchronous receiver transmitter (UART) 260. These interface devices may be integrated (“on-chip”) with the peripheral devices, or in alternate embodiments, may be discrete components. The interface devices may also be referred to as peripheral devices. External memory controller 210, display controller 220, camera controller 230, and audio controller 240 may be connected to bus 170. SPI 250 and UART 260 may be connected to bus 180.

Although the scope of the claimed subject matter is not limited in this respect, buses 170, 180, and 190 may be data paths comprising, for example, a collection of data lines to transmit information from one part of computing system 100 to another. Processor 110 may comprise, for example, one or more microprocessors, digital signal processors, microcontrollers, or the like. Processor 110 may execute a software process such as, for example, a software program or an operating system, wherein the software process may use digital information such as, for example, data and/or instructions.

Internal memory 270 may be referred to as a storage device and may be adapted to store information such as, for example, instructions or data used by an operating system or a software program that may be executed by processor 110. In some embodiments, internal memory 270 may be a volatile memory such as, for example, a static random access memory (SRAM) or a dynamic random access memory (DRAM), although the scope of the claimed subject matter is not limited in this respect. In alternate embodiments, internal memory 270 may be nonvolatile memory such as, for example, an electrically programmable read-only memory (EPROM), an electrically erasable and programmable read only memory (EEPROM), or a flash memory (NAND or NOR type, including multiple bits per cell).

It should be noted that herein, the terms data and information may be used in interchangeably. For example, data may also refer to both data and/or instructions. In addition, the terms information and data may refer to a single bit of information or more than one bit of information.

In some embodiments, bus controllers 120, 130, and 140 may be used with processor 110 or DMA controller 150 to control the transfer of information within computing system 100. Bus controllers 120, 130, and 140 may include buffers, queues, or registers to store information and may also comprise circuitry adapted to generate control, address, and data signals to control the transfer of information in computing system 100. For example, bus controllers 120, 130, and 140 may generate control signals, address signals, and data signals that may be associated with a particular write or read operation to the various devices in computing system 100.

As stated above, processor 110 may also be used with bus controllers 120, 130, and 140 to control the transfer of information. For example, processor 110 may provide data, address, and control information to bus controllers 120, 130, and 140 to initiate a transfer of information between the various peripheral and internal devices of computing system 100.

DMA controller 150 may be used with bus controllers 120, 130, and 140 to control the transfer of information between memory devices in computing system 100 or control the transfer of information between a memory device and a peripheral device in computing system 100. DMA controller 150 may perform a transfer of information to or from a memory device without using processor 110. Transfers using DMA controller 150 may be referred to as DMA transfers.

DMA controller 150 may have a predetermined number of DMA channels, wherein each channel may be dedicated to a specific device or devices in computing system 100. DMA controller 150 may include a predetermined number of DMA request input terminals to receive DMA requests from memory devices or peripheral devices in computing system 100. In response to receiving a DMA request, DMA controller 150 may initiate a DMA transfer. If a peripheral device or memory device is adapted to transmit a DMA request to one of the DMA request input terminals, then the peripheral device or memory device may be referred to as a DMA device and may be said to have a DMA interface. The DMA interface of a DMA device may provide handshaking between DMA controller 150 and the DMA device to transfer information to and from the DMA device.

Non-DMA devices may be devices that have no DMA interface, e.g., these devices may not have access to a DMA request input terminal. In some embodiments, a non-DMA device may use processor 110, rather than DMA controller 150, to transfer information to and from the non-DMA device. Internal memory 270, SPI 250, UART 260, and controllers 210, 220, 230, and 240 may be configured as either DMA devices or non-DMA devices.

As an example, camera controller 230 may be connected to a camera (not shown). Camera controller 230 may be a DMA interface, i.e., in this example, camera controller 230 may be adapted to send a DMA request to a DMA request input terminal of DMA controller 150 via bus 170 and external bus controller 120. In this example, the camera and camera controller 230 may be referred to a DMA device having a DMA interface. DMA controller 150 may be used to transfer a block of data from the camera to internal memory 270. In this example, prior to a DMA request, processor 110 may supply to DMA controller 150 the following: a source address, a destination address, and the size of the data transfer. The source address may be the location of the block of data in the camera and the destination address may be the location of where the data is to placed in internal memory 270 during the DMA transfer. Camera controller 230 may be configured to trigger the DMA transfer by generating a DMA request.

The DMA request may be transferred from camera controller 230 to one of the DMA request input terminals via bus 170 and external bus controller 120. In response to the DMA request, DMA controller 150 may transmit a signal to processor 110 indicating that DMA controller 150 is to take control of buses 170 and 190. After processor 110 releases control of buses 170 and 190, DMA controller 150 may transmit a DMA acknowledge signal to camera controller 230. During the DMA transfer, buses 170 and 190 may be driven by DMA controller 150, not processor 110, and DMA controller 150 may generate the appropriate signals to perform the DMA transfer. During a DMA transfer, data may be transferred directly from the camera to internal memory 270, or in alternate embodiments, data may go through DMA controller 150. In this embodiment, during the DMA transfer, the block of data may be initially transferred from the camera to external bus controller 120 via bus 170, the block of data may then be transferred from external bus controller 120 to internal bus controller 140, and the block of data may then be transferred from internal bus controller 140 to internal memory 270 via bus 190.

DMA request generator 160 may be connected to buses 170, 180 and 190 to monitor activity on these buses. DMA request generator 160 may be connected to one or more of the DMA request input terminals of DMA controller 150.

DMA request generator 160 may monitor activity of a signal transferred on a bus during a transfer of information to or from a device using the bus and DMA request generator 160 may generate a DMA request based on the bus activity. In some embodiments, DMA request generator 160 may monitor activity on bus 170 during a transfer of information to or from controller 210, controller 220, controller 230, or controller 240. In addition, DMA request generator 160 may monitor activity on bus 180 during a transfer of information to or from SPI 250, or UART 260. Further, DMA request generator 160 may monitor activity on bus 190 during a transfer of information to or from internal memory 270.

DMA request generator 160 may be adapted to detect DMA events and may generate a DMA trigger in response to the DMA event. In some embodiments, DMA request generator 160 may be connected to external dedicated pins (not shown) to detect a DMA event. DMA events may be predefined events. For example, although the scope of the claimed subject matter is not limited in this respect, the completion of the transfer of a block of information from a device may be defined as a DMA event. Alternatively, a request to transfer information from a non-DMA device may be a DMA event.

DMA request generator 160 may monitor a bus coupled to the device to determine if the DMA event occurred, e.g., if the transfer of the block of information from the device is complete. In response to the detection of a DMA event, DMA request generator 160 may generate a DMA request and may transfer this request to one of the DMA request input terminals of DMA controller 150. In other words, DMA request generator 160 may be adapted to monitor a bus to determine if a transfer of a block of information from a device is complete and may be adapted to generate a DMA request if the transfer of the block of information from the device is complete. In response to receiving the DMA request from DMA request generator 160, DMA controller 150 may respond in many ways. For example, DMA controller 150 may initiate a DMA transfer of the block of information to another device, or in alternate embodiments, DMA controller 150 may initiate another transfer of another block of information from the device.

To determine if the transfer of a block of information from a device is complete, DMA request generator 160 may monitor one or many signals on a bus. For example, DMA request generator 160 may monitor chip select (CS) signals of peripheral or memory devices, access signals (e.g., read or write signals) transmitted over the bus, or address signals on the bus.

In some embodiments, DMA controller 150 may be used to transfer information from a non-DMA device. For example, if camera controller 230 is a non-DMA device, then DMA request generator 160 may monitor bus activity on bus 170 to determine if information is to be transferred from camera controller 230. A signal on bus 170 coupled to camera controller 230 may indicate that information is ready to be transferred from camera controller 230, then request generator 160 may generate a DMA request to initiate a DMA transfer from camera controller 230 using DMA controller 150.

In some embodiments, DMA request generator 160 may control the timing of the transfer of a DMA request to DMA controller 150. For example, DMA request generator 160 may transmit a DMA request to DMA controller 150 after a predetermined delay or a predetermined amount of time after detecting a DMA event or after receiving a DMA trigger. In alternate embodiments, DMA request generator 160 may transfer a DMA request to DMA controller 150 immediately following receiving DMA trigger. Or, DMA request generator 160 may transfer a DMA request to DMA controller 150 after detecting a predetermined number of DMA events. By controlling the timing of sending a DMA request to DMA controller 150, DMA request generator 160 may control and balance the flow of information in computing system 100.

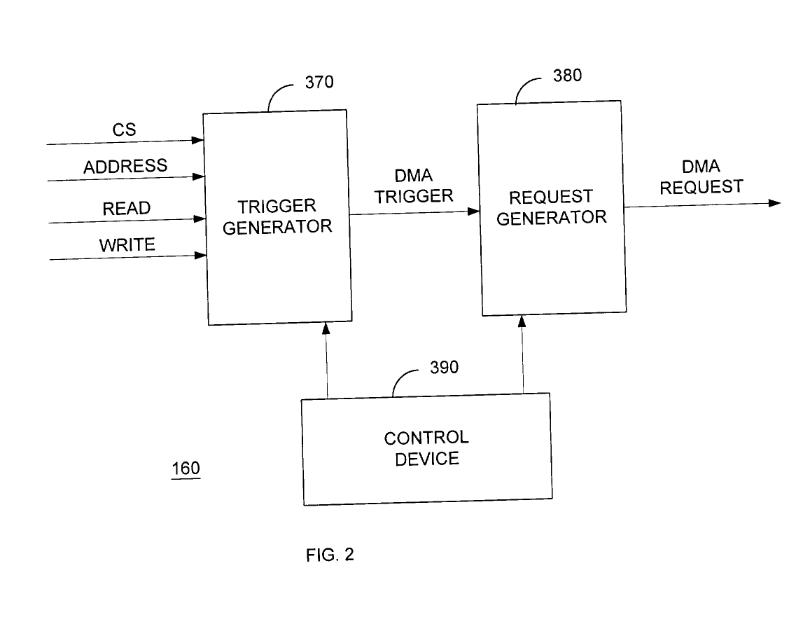

Turning to FIG. 2, an embodiment of DMA request generator 160 is illustrated in accordance with an embodiment of the claimed subject matter. In this embodiment, DMA request generator 160 may comprise a trigger generator 370, a request generator 380 connected to trigger generator 370, and a control device 390 connected to trigger generator 370 and request generator 380.

Trigger generator 370 may be connected to buses 170, 180, and 190 to monitor activity on these buses. Trigger generator 370 may generate a DMA trigger in response to activity on buses 170, 180, and 190. The DMA trigger may be transferred to request generator 380.

Request generator 380 may be connected to one or more than one of the DMA request input terminals of DMA controller 150. In some embodiments, in response to a DMA trigger, request generator 380 may immediately transmit a DMA request to one of the DMA request input terminals to initiate a DMA transfer. In alternate embodiments, request generator 380 may transmit a DMA request to DMA controller 150 a predetermined amount of time after receiving a DMA trigger. In other embodiments, request generator 380 may transmit a DMA request to DMA controller 150 after receiving multiple DMA triggers. For example, request generator 380 may be configured to transmit a DMA request to DMA controller 150 after receiving at least three DMA triggers.

Control device 390 may be adapted to control and configure trigger generator 370 and request generator 380. In some embodiments, control device 390 may be connected to processor 110 to receive configuration information from processor 110. For example, processor 110 may define what information trigger generator 370 monitors on buses 170, 180, and 190. In addition, processor 110 may define under what conditions and when request generator 380 generates a DMA request.

Referring to both FIGS. 1 and 2, as an example, two blocks of information may be transferred from a camera (not shown) which may be coupled to camera controller 230. The two blocks of information may be transferred to internal memory 270. Two separate transfer operations may be used to transfer the two blocks of information, wherein each transfer includes transmitting a block of information in stages from the camera to internal memory 270. For example, during an initial stage, a block of information may initially be transferred to camera controller 230. During the next stage, the block of information may be transferred from camera controller 230 to external bus controller 120 via bus 170. In the following stage, the block of information may be transferred from external bus controller 120 to internal bus controller 140. In a final stage, the block of information may be transferred from internal bus controller 140 to internal memory 270 via bus 190.

Camera controller 230 may be a relatively slow device compared to, for example, controllers 120, 130, and 140, processor 110, DMA controller 150, DMA request generator 160, and internal memory 270. Accordingly, the transfer of information from camera controller 230 to external bus controller 120 may be relatively slow compared to, for example, the transfer of information between external bus controller 120 and internal bus controller 140 or compared to the transfer of information between internal bus controller 140 and internal memory 270.

In some embodiments, while the initial block of information is transferred from camera controller 230 to external bus controller 120, DMA request generator 160 may monitor bus 170 to determine if the transfer of the initial block of information from camera controller 230 is complete. During this transfer, DMA controller 150 may be free to perform a DMA transfer between other devices in computing system 100 since DMA request generator 160 is monitoring the transfer of information between camera controller 230 and external bus controller 120. For example, during the transfer of the initial block of information between camera controller 230 and external bus controller 120, rather than having DMA controller 150 in an idle state waiting for this transfer to complete, DMA controller 150 may be used to assist the transfer of information between, for example, SPI 250 and internal memory 270. DMA request generator 160 may monitor bus 170 to determine if the transfer of the initial block of information from camera controller 230 is complete. If the transfer of the initial block of information from camera controller 230 is complete, DMA request generator 160 may transmit a DMA request to DMA controller 150 to initiate a DMA transfer of the second block of information from camera controller 230.

DMA request generator 160 may monitor one or many signals on bus 170. For example, DMA request generator 160 may monitor a chip select (CS) signal transmitted to a CS input terminal of camera controller 230. If the CS signal transferred to camera controller 230 is asserted low during a read operation, then trigger generator 370 may be configured to detect a rising edge of the CS signal to determine if the transfer of information from camera controller 230 is complete. If trigger generator 370 detects a rising edge of the CS signal, then trigger generator 370 may generate a DMA trigger and transmit the DMA trigger to request generator 380. In other words, if trigger generator 370 detects that the CS signal transitions from a relatively lower voltage level to a relatively higher voltage potential, then trigger generator 370 may transmit a DMA trigger to request generator 380.

In alternate embodiments, DMA request generator 160 may monitor access signals (e.g., a read signal or a write signal) transferred to input terminals of camera controller 230 via bus 170. For example, if a read signal transmitted to camera controller 230 is asserted low during a read operation, then trigger generator 370 may be configured to detect a rising edge of the read signal to determine if the transfer of information from camera controller 230 is complete. In other embodiments, DMA request generator 160 may monitor address or data signals transferred to input terminals of camera controller 230 via bus 170. One or more of the address or data signals transmitted to camera controller 230 may provide an indication of when the transfer of information from camera controller 230 is complete. For example, the level or value of one or more signals may be compared to a predetermined level or value to determine if the transfer of information from camera controller 230 is complete. Trigger generator 370 may be configured to perform the comparison to determine if the transfer of information from camera controller 230 is complete. If the level or value equals the predetermined level or value, then trigger generator 370 may be configured to generate a DMA trigger.

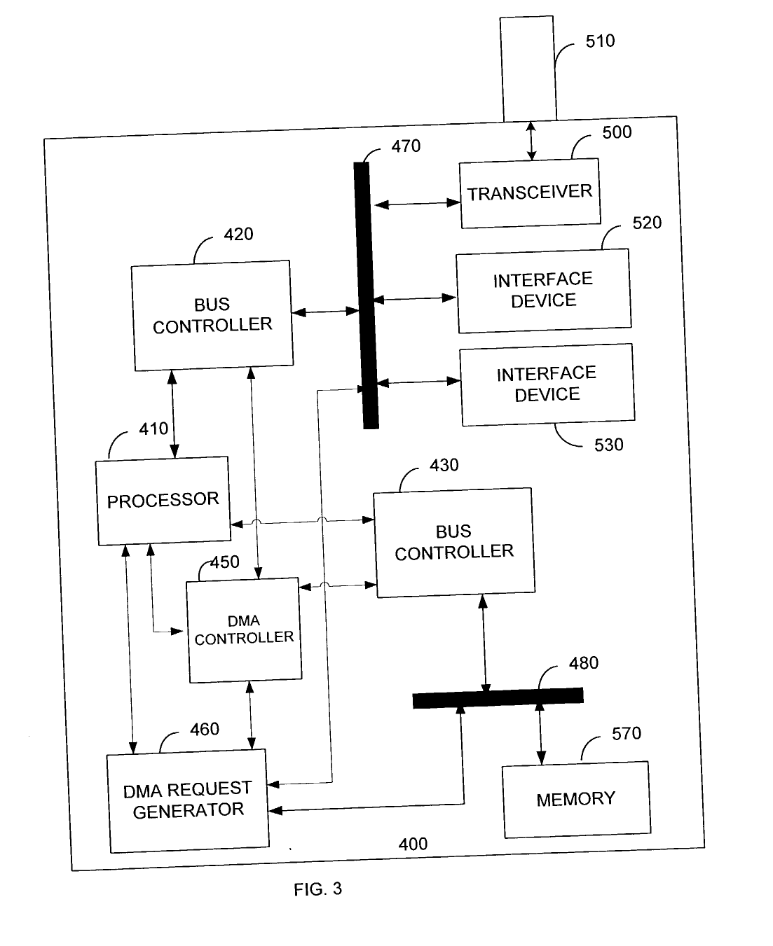

Turning to FIG. 3, a portable communication device 400 in accordance with an embodiment of the claimed subject matter is described. Portable communication device 400 may include a processor 410 that may be connected to a bus controller 420, a bus controller 430, a DMA controller 450, and a DMA request generator 460. DMA controller 450 may be connected to bus controller 420, bus controller 430, and DMA request generator 460. Bus controller 420 may be connected to a bus 470 and bus controller 430 may be connected to a bus 480. DMA request generator 460 may be connected to buses 470 and 480. Portable communication device 400 may further comprise a memory 570 connected to bus 480. A wireless transceiver 500 may be connected to an antenna 510 and bus 470. In addition, portable communication device 400 may include interface devices 520 and 530, both may be connected to bus 470.

Referring to FIGS. 1 and 3, the operation of interface devices 520 and 530 may be similar to the operation of SPI 250, UART 260, controller 210, controller 220, controller 230, or controller 240. The operation of bus controller 420 may be similar to the operation of external bus controller 120 or communication bus controller 130. The operation of bus controller 430 may be similar to the operation of internal bus controller 140. The operation of processor 410, DMA controller 450, and DMA request generator 460 may be similar to the operations of processor 110, DMA controller 150, and DMA request generator 160, respectively.

Portable communication device 400 may use wireless transceiver 500 with antenna 510 to transmit and receive messages to and from a wireless communication network with a radio frequency (RF) signal.

Although the scope of the claimed subject matter is not limited in this respect, portable communication device 400 may use one of the following communication air interface protocols to transmit and receive messages: Code Division Multiple Access (CDMA), cellular radiotelephone communication systems, Global System for Mobile Communications (GSM) cellular radiotelephone systems, North American Digital Cellular (NADC) cellular radiotelephone systems, Time Division Multiple Access (TDMA) systems, Extended-TDMA (E-TDMA) cellular radiotelephone systems, third generation (3G) systems like Wide-band CDMA (WCDMA), CDMA-2000, and the like.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A method, comprising:
monitoring activity on a bus during a transfer of information from a device using the bus; and
generating a direct memory access (DMA) request based on the activity on the bus.

2. The method of claim 1, wherein generating comprises generating the DMA request if a signal on the bus indicates that the transfer of information from the device using the bus is complete.

3. The method of claim 1, wherein generating comprises generating the DMA request if a signal on the bus transitions from a first level to a second level.

4. The method of claim 1, wherein generating comprises generating the DMA request if a signal on the bus is at a predetermined level.

5. The method of claim 1, wherein monitoring comprises monitoring the bus to detect a DMA event.

6. The method of claim 5, wherein generating further comprises generating the DMA request in response to the DMA event.

7. The method of claim 5, further comprising generating the DMA request in response to a predetermined number of DMA events.

8. The method of claim 5, further comprising generating the DMA request in response to the DMA event, wherein the DMA request is generated a predetermined amount of time after the DMA event.

9. The method of claim 5, wherein the DMA event is an event indicating that the transfer of information from the device using the bus is complete.

10. A method, comprising:
using a direct memory access (DMA) controller to transfer information from a non-DMA device.

11. The method of claim 10, further comprising monitoring a bus coupled to the non-DMA device to determine if information is ready to be transferred from the non-DMA device.

12. The method of claim 11, further comprising generating a DMA request if a signal on the bus coupled to the non-DMA device indicates that information is ready to be transferred from the non-DMA device.

13. An apparatus, comprising:
a first device adapted to determine if a transfer of information from a second device is complete and adapted to generate a direct memory access (DMA) request if the transfer of the information from the second device is complete.

14. The apparatus of claim 13, further comprising a bus coupled to the second device, wherein the first device monitors a signal on the bus to determine if the transfer of information from the second device is complete.

15. The apparatus of claim 13, wherein the second device is a non-DMA device.

16. The apparatus of claim 13, further comprising a DMA controller coupled to the first device, wherein the DMA controller is adapted to receive the DMA request and adapted to transfer information from or to the second device in response to the DMA request.

17. The apparatus of claim 16, wherein the DMA controller has at least two DMA request input terminals to receive the DMA request and wherein the second device is a non-DMA device and the second device is not connected to any of the DMA request input terminals of the DMA controller.

18. A system, comprising:
a processor;
a wireless transceiver coupled to the processor;
a bus coupled to the processor;
a first device coupled to the bus; and
a second device adapted to monitor the bus to determine if a transfer of information from the first device is complete and adapted to generate a direct memory access (DMA) request if the transfer of the information from the second device is complete.

19. The system of claim 18, further comprising a DMA controller coupled to the second device.

20. The system of claim 19, wherein the DMA controller has a DMA request input terminal to receive the DMA request and wherein the first device is not connected to any of the DMA request input terminals of the DMA controller.
